(19) United States
(12) Patent Application Publication
(10) Pub. No.: US 2008/0043184 A1
(43) Pub. Date: Feb. 21, 2008

(54) TRANSFLECTIVE LIQUID CRYSTAL DISPLAY PANEL

(76) Inventors: Hsiu-Chi Tung, Taipei City (TW); Chih-Ming Chang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/535,076

(22) Filed: Sep. 26, 2006

(30) Foreign Application Priority Data
Aug. 18, 2006 (TW) 095130544

(51) Int. Cl. G02F 1/1335

(52) U.S. Cl. 349/114

(57) ABSTRACT

A transflective liquid crystal display panel includes an array substrate having a plurality of pixels, a plurality of scan lines and data lines electrically connected to the pixels. Each pixel includes a reflection region and a transmission region. The transflective liquid crystal display panel includes an organic light-shielding pattern disposed on the border between the reflection region and the transmission region of at least one pixel of the array substrate.

### DESCRIPTION

This application claims the benefit of Taiwan Patent Application Serial No. 95130544, filed Aug. 18, 2006, the subject matter of which is incorporated herein by reference.

### BACKGROUND OF THE INVENTION

1. Field of the Invention

The present invention relates to a transflective liquid crystal display panel, more specifically, to a transflective liquid crystal display panel including an organic light-shielding pattern.

2. Description of the Prior Art

Liquid crystal displays can be divided into three kinds: transmissive, reflective, and transflective modes. The transmissive liquid crystal display has a backlight for providing light. The light provided by the backlight will pass through the liquid crystal panel to let a user see the image displayed on the liquid crystal display screen. The reflective liquid crystal display has a reflective electrode. When displaying the image, the ambient light of the reflective liquid crystal display will enter the liquid crystal display from the observer side of the liquid crystal display and then be reflected by the reflective electrode. The reflected light will pass through the liquid crystal panel again, and finally the user can see the image displayed on the liquid crystal display. In addition, the transflective liquid crystal display both has the liquid crystal display of transmissive mode and reflective mode. In other words, each pixel of the liquid crystal display panel comprises both a transmissive area and a reflective area, where the transmissive area uses a backlight, and the reflective area use an ambient light as a light source.

Please refer to FIG. 1, which is a schematic diagram of a prior art transflective liquid crystal display panel. As shown in FIG. 1, the prior art transflective liquid crystal display panel 10 comprises an array substrate 20, a color filter substrate 30 and a liquid crystal layer 40 disposed between the array substrate 20 and the color filter substrate 30. The array substrate 20 comprises a plurality of pixels 22, and each pixel 22 comprises a reflection region 221 and a transmission region 222. The array substrate 30 also comprises a plurality of thin-film transistors 23 disposed in each reflection region 221, a plurality of reflective electrodes 24 disposed on the thin-film transistors 23 and a plurality of transmissive electrodes (not shown in figure) disposed in the transmission region 222. In addition, a transparent dielectric layer 26 is included between the reflective electrodes 24 and the thin-film transistors 23. The color filter substrate 30 comprises a plurality of color filters 32 disposed corresponding to the pixels 22 and black matrixes 34 corresponding to an edge of each pixel 22.

FIG. 1 is the prior art transflective liquid crystal display panel 10 of double cell gap design. The effect of the transparent dielectric layer 26 below the reflective electrode 24 is to adjust the gap (thickness) of the liquid crystal layer 40. Due to the disposal of the transparent dielectric layer 26, the gap of the liquid crystal layer 40 in the reflection region 221 is smaller than that in the transmission region 222 so as to let light have the same phase difference while passing through the reflection region 221 and the transmission region 222. Although the transparent dielectric layer 26 can adjust the phase difference of the light in the liquid crystal layer 40, the transmission region 222 in the border between the reflection region 221 and the transmission region 222 has an obvious drop in height.

### SUMMARY OF THE INVENTION

According to the claimed invention, a transflective liquid crystal display panel is provided. The transflective liquid crystal display panel comprises an array substrate, and the array substrate comprises a plurality of pixels, a plurality of scan lines electrically connected to the pixels and a plurality of data lines electrically connected to the pixels. Each pixel has a transmission region and a reflection region, and the transflective liquid crystal display panel comprises an organic light-shielding pattern disposed on the border between the reflection region and the transmission region of at least one pixel of the array substrate.

According to the claimed invention, a transflective liquid crystal display panel is provided. The transflective liquid crystal display panel comprises an array substrate, and the array substrate comprises a plurality of pixels, a plurality of scan lines electrically connected to the pixels and a plurality of data lines electrically connected to the pixels. Each pixel has a transmission region and a reflection region, and the transflective liquid crystal display panel comprises an organic light-shielding pattern disposed on the border or in the region between the transmission region of at least one pixel and the data line on the array substrate.

According to the claimed invention, a transflective liquid crystal display panel is provided. The transflective liquid crystal display panel comprises an array substrate, and the array substrate comprises a plurality of pixels, a plurality of scan lines electrically connected to the pixels and a plurality of data lines electrically connected to the pixels. Each pixel has a transmission region and a reflection region, and the transflective liquid crystal display panel comprises an organic light-shielding pattern disposed on the array substrate and surrounding the transmission region of at least one pixel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art transflective liquid crystal display panel.

FIG. 2 is a top view of a pixel of the transflective liquid crystal panel according to a preferred embodiment of the present invention.

FIG. 3 is a cross-sectional view of a pixel of the transflective liquid crystal panel, taken along a cross-sectional line AA′ of FIG. 2.

FIG. 4 is a schematic diagram of a pixel of the transflective liquid crystal display panel according to another preferred embodiment of the present invention.

FIG. 5 is a cross-sectional view of a pixel of the transflective liquid crystal panel, taken along a cross-sectional line BB′ of FIG. 4.

FIG. 6 is a schematic diagram of a pixel of the transflective liquid crystal display panel according to another preferred embodiment of the present invention.

### DETAILED DESCRIPTION

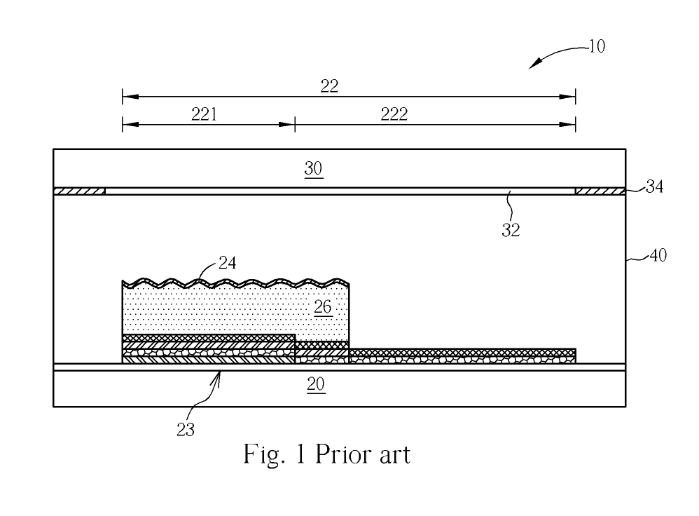

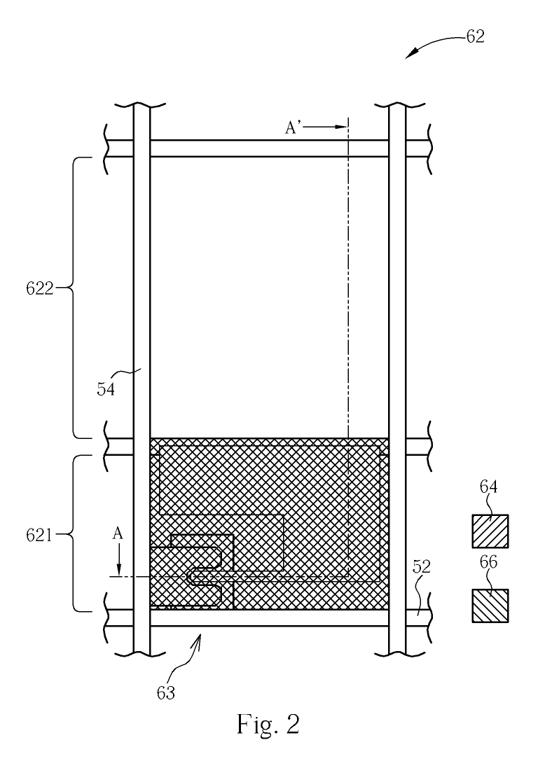

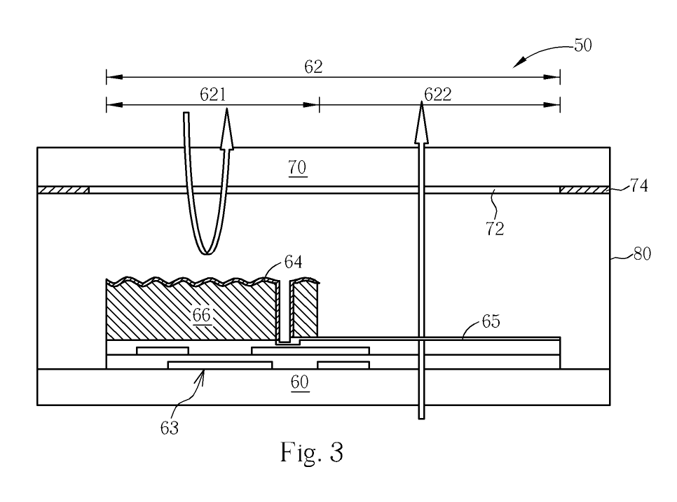

As shown in FIG. 1, according to the conventional transflective liquid crystal panel, the drop in height of the liquid crystal layer 40 may make a bad arrangement of liquid crystal molecules so as to result a light leakage problem. In addition, the liquid crystal molecules above the data line or scan line may also be easily affected by the signal disturbance, such as crosstalk problems, to result a light leakage problem. Please refer to FIG. 2 and FIG. 3. FIG. 2 is a top view of a pixel of the transflective liquid crystal panel according to a preferred embodiment of the present invention. FIG. 3 is a cross-sectional view of a pixel of the transflective liquid crystal panel, taken along a cross-sectional line AA′ of FIG. 2. As shown in FIG. 2 and FIG. 3, the transflective liquid crystal display panel 50 of the present embodiment comprises an array substrate 60, a color filter substrate 70 and a liquid crystal layer 80 disposed between the array substrate 60 and the color filter substrate 70. The array substrate 60 comprises a plurality of scan lines 52 and a plurality of data lines 54 arranged substantially perpendicular to the scan lines 52. A plurality of pixels 62 is defined among the scan lines 52 and the data lines 54, and each pixel 62 comprises a reflection region 621 and a transmission region 622. The color filter substrate 70 comprises a plurality of color filters 72 disposed corresponding to the pixels 62 and a black matrix 74 corresponding to an edge of each pixel 62. The array substrate 60 further comprises a plurality of thin-film transistors 63 disposed in each reflection region 621 respectively, a plurality of reflective electrodes 64 disposed on the thin-film transistor 63 and a plurality of transmissive electrodes 65 disposed in the transmission region 622.

In the transflective liquid crystal display panel 50 of the embodiment of the present invention, there is a light-shielding pattern which may be an organic light-shielding pattern 66 included between the reflective electrode 64 and the thin-film transistor 63, and the organic light-shielding pattern 66 not only has an effect of adjusting a cell gap but also shielding a leakage of light so as to have no requirement to dispose an extra light-shielding design. The design of the organic light-shielding pattern 66 should consider its light-shielding effect in choosing its material, so the light-shielding ratio of the organic light-shielding pattern 66 should be over about 70%. In other words, the transmissive transmittance should be from about 0% to about 30%. The material of the organic light-shielding pattern 66 can be various kinds of organic materials, such as resin or using a doping or mixing method to adjust its transmissive transmittance to reach an acceptable transmissive transmittance. The resin can use a black resin or grey resin etc., and the doping or mixing materials can be metal, such as chromium, metal oxide, such as chromium oxide, mixtures thereof or nonmetals, such as carbon, etc. For example, the material of the organic light-shielding pattern 66 can be a brown resin formed by positive photosensitive dye and novalac polymer, a black resin formed by positive photosensitive color pigment and acrylic resin adhesive or a black resin formed by negative black pigment and acrylic monomer etc.

The organic light-shielding pattern 66 of the embodiment is disposed in the reflection region 621 of the pixel 62 and on the border between the reflection region 621 and the transmission region 622. Therefore, the organic light-shielding pattern 66 in the reflection region 621 can heighten the reflective electrode 64 to form a double cell gap, so the organic light-shielding pattern 66 on the border between the reflection region 621 and the transmission region 622 can perform the light-shielding effect to prevent light leakage.

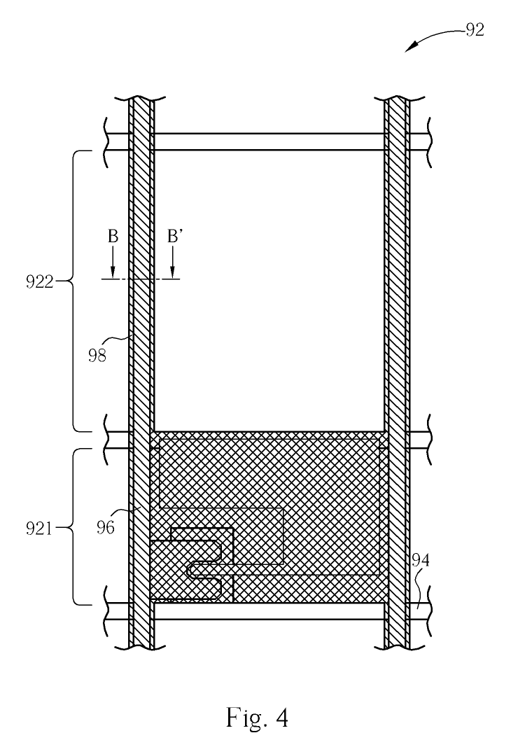

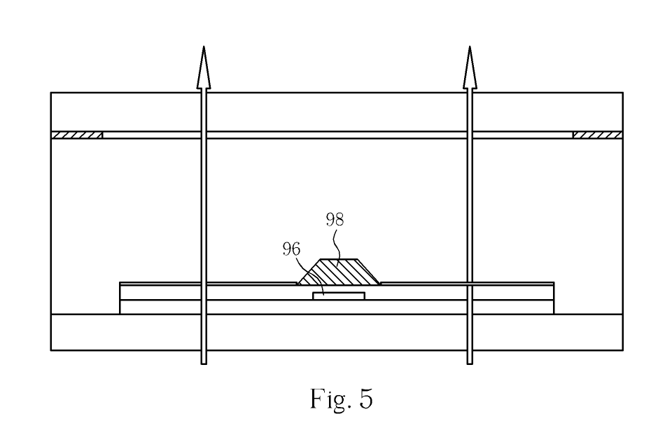

According to the present invention, other types of embodiments are provided to solve a problem of liquid crystal molecules on the data lines or the scan lines easily producing the light leakage. Please refer to FIG. 4 and FIG. 5. FIG. 4 is a schematic diagram of a pixel of the transflective liquid crystal display panel according to another preferred embodiment of the present invention. FIG. 5 is a cross-sectional view of a pixel of the transflective liquid crystal panel, taken along a cross-sectional line BB′ of FIG. 4. In the following embodiment, a basic structure of the transflective liquid crystal display panel has been disclosed in the above-mentioned embodiment, so no repeated statement thereof is in the following. As shown in FIG. 4, a pixel 92 of the transflective liquid crystal display panel is defined by the scan lines 94 and the data lines 96, and each pixel 92 comprises a reflection region 921 and a transmission region 922. In the embodiment, the organic light-shielding pattern 98 is not only disposed in the reflection region 921 and on the border between the reflection region 921 and the transmission region 922 but also covering the data lines 96 and on the border between the transmission region 922 and the transmission region 922 adjacent thereto. As shown in FIG. 5, according to the above-mentioned disposition, the organic light-shielding pattern 98 can avoid the area adjacent to the data lines 96 light leakage.

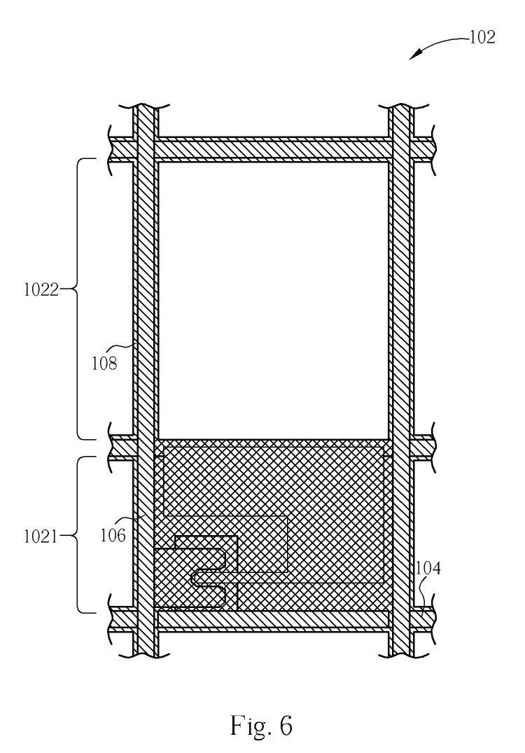

Please refer to FIG. 6, which is a schematic diagram of a pixel of the transflective liquid crystal display panel according to another preferred embodiment of the present invention. As shown in FIG. 6, a pixel 102 of the transflective liquid crystal display panel is defined by the scan lines 104 and the data lines 106, and each pixel 102 comprises a reflection region 1021 and a transmission region 1022. Differing from the above-mentioned embodiment, the organic light-shielding pattern 108 of the embodiment is not only disposed in the reflection region 1021 but also disposed surrounding the transmission region 1022. That is to say that the organic light-shielding pattern 108 covers the scan lines 104 and the data lines 106. According to the above-mentioned disposition, the organic light-shielding pattern 108 can avoid light leakage when the surrounding area of the pixel 102 is lit.

One of the particulars of the present invention is to solve the light leakage problem by using the organic light-shielding pattern, and the application of the present invention is not limited to the above-mentioned embodiment. The position of the organic light-shielding pattern can be adjusted according to the different position of the pixel of the transflective liquid crystal display panel so as to achieve the best light-shielding effect. Moreover, the organic light-shielding pattern is not limited to have only one thickness and can have different thickness according to the light-shielding effect or the consideration in the process in different position of the pixel region. In addition, the material of the organic light-shielding pattern is not limited to the material disclosed in the above-mentioned embodiment and can use any other material having light-shielding characteristics and compatible with the process.

In summary, the present invention uses the organic light-shielding pattern having light-shielding function to replace a conventional transparent dielectric layer. Therefore, the organic light-shielding pattern not only has a function to form the double cell gap but also can directly perform a light-shielding function to solve the light leakage problem, so there is no requirement to extra add cost to dispose the extra light-shielding device and even no problem of affecting aperture ratio.

Those skilled in the art will readily observe that numerous modifications and alterations of the device and method may be made while retaining the teachings of the invention. Accordingly, the above disclosure should be construed as limited only by the metes and bounds of the appended claims.

1. A transflective liquid crystal display panel, comprising:
an array substrate comprising:
a plurality of pixels, each pixel having a transmission region and a reflection region;
a plurality of scan lines electrically connected to the pixels;
a plurality of data lines electrically connected to the pixels; and
a light-shielding pattern disposed substantially between the reflection region and the transmission region of at least one pixel of the array substrate;
a reflective electrode disposed on the surface of the light-sheilding pattern; and
a transmissive electrode disposed in the transmission region.

2. The transflective liquid crystal display panel of claim 1, wherein a transmissive transmittance of the light-shielding pattern is from about 0% to about 30%.

3. The transflective liquid crystal display panel of claim 1, wherein the light-shielding pattern is comprised of resin.

4. The transflective liquid crystal display panel of claim 1, wherein the light-shielding pattern is doped with a substance.

5. The transflective liquid crystal display panel of claim 4, wherein the substance comprises metal, metal oxide, nonmetal, carbon or mixtures thereof.

6. The transflective liquid crystal display panel of claim 1, wherein the light-shielding pattern is further disposed in at least one of the reflection regions.

7. The transflective liquid crystal display panel of claim 1, wherein the light-shielding pattern is further disposed between each of the transmission regions and each of the adjacent scan lines.

8. The transflective liquid crystal display panel of claim 1, wherein the light-shielding pattern is further disposed between each of the transmission regions and each of the adjacent data lines.

9. The transflective liquid crystal display panel of claim 1, wherein the light-shielding pattern is further disposed on the data lines.

10. The transflective liquid crystal display panel of claim 1, wherein the light-shielding pattern is comprised of organic material.

11. A transflective liquid crystal display panel, comprising:
an array substrate comprising:
a plurality of pixels, each pixel having a transmission region and a reflection region;
a plurality of scan lines electrically connected to the pixels;
a plurality of data lines electrically connected to the pixels; and
a light-shielding pattern disposed on the array substrate and substantially surrounding the transmission region of at least one the pixel.

12. The transflective liquid crystal display panel of claim 11, wherein a transmissive transmittance of the light-shielding pattern is from about 0% to about 30%.

13. The transflective liquid crystal display panel of claim 11, wherein the light-shielding pattern is comprised of resin.

14. The transflective liquid crystal display panel of claim 11, wherein the light-shielding pattern is doped with a substance comprising metal, metal oxide, nonmetal, carbon or mixtures thereof.

15. The transflective liquid crystal display panel of claim 11, wherein the light-shielding pattern is further disposed in each of the reflection regions.

16. The transflective liquid crystal display panel of claim 11, wherein the light-shielding pattern is comprised of organic material.

17. A transflective liquid crystal display panel, comprising:
an array substrate comprising:
a plurality of pixels, each pixel having a transmission region and a reflection region;
a plurality of scan lines electrically connected to the pixels;
a plurality of data lines electrically connected to the pixels; and
a light-shielding pattern disposed substantially between the data line and the transmission region of at least one pixel on the array substrate.

18. The transflective liquid crystal display panel of claim 17, wherein a transmissive transmittance of the light-shielding pattern is from about 0% to about 30%.

19. The transflective liquid crystal display panel of claim 17, wherein the light-shielding pattern is comprised of resin.

20. The transflective liquid crystal display panel of claim 17, wherein the light-shielding pattern is doped with a substance comprising metal, metal oxide, nonmetal, carbon or mixtures thereof.

21. The transflective liquid crystal display panel of claim 17, wherein the light-shielding pattern is comprised of organic material.
